(19) United States
(12) Patent Application Publication
(10) Pub. No.: US 2025/0307643 A1
(43) Pub. Date: Oct. 2, 2025

(54) MULTI-AGENT REINFORCEMENT LEARNING PROCESSES

(71) Applicant: Telefonaktiebolaget LM Ericsson (publ), Stockholm (SE)

(72) Inventors: Klaus RAIZER, INDAIATUBA (BR); Konstantinos VANDIKAS, Solna (SE); Anil Ramachandran NAIR, Nagawara, Bangalore, Karnataka (IN); Hassam RIAZ, Järfälla (SE)

(73) Assignee: Telefonaktiebolaget LM Ericsson (publ), Stockholm (SE)

(21) Appl. No.: 18/862,948

(22) PCT Filed: May 3, 2023
(86) PCT No.: PCT/EP2023/061623

§ 371 Date: Nov. 5, 2024

(30) Foreign Application Priority Data
May 30, 2022 (GR) 20220100447

(51) Int. Cl. G06N 3/092; G06N 3/098

(52) U.S. Cl. CPC G06N 3/092; G06N 3/098

(57) ABSTRACT

A method performed by a first node in a communications network, as part of a multi-agent reinforcement learning, RL, process involving a second node in the communications network. The method comprises: i) predicting first state-action-reward, s-a-r, information for the second node; ii) determining a first q-value, according to the multi-agent RL process, using the predicted first s-a-r as the contribution from the second node; iii) determining a second q-value, according to the multi-agent RL process, without taking a contribution from the second node into consideration; and iv) selecting a first action for the first node based on the first q-value and the second q-value.

### CROSS-REFERENCE TO RELATED APPLICATIONS

This patent application is a submission under 35 U.S.C. § 371 for U.S. national stage patent application of international application no. PCT/EP2023/061623 filed on May 3, 2023 and entitled “MULTI-AGENT REINFORCEMENT LEARNING PROCESSES,” which claims priority to GR 20220100447 filed on May 30, 2022, the entireties of both of which are incorporated herein by reference.

### TECHNICAL FIELD

This disclosure relates to methods, nodes and systems in a communications network. More particularly but non-exclusively, the disclosure relates to a multi-agent reinforcement learning, RL, process involving a first node and a second node in a communications network.

### BACKGROUND

In dynamic environments, such as smart manufacturing environments, where metallic objects and machinery are regularly moved around, it can be difficult to plan optimal positioning of radio transmission units, (e.g., Dots), as new configurations often cause interference that degrades Quality of Service, QoS. Interference can lead to blind spots in coverage, e.g. areas with low Reference Signal Received Power (RSRP) or Reference Signal Received Quality (RSRQ). To make the problem worse, these shadows might be cast at areas containing equipment that relies on wireless communication to provide critical services like, for instance, static devices monitoring critical processes, heavy machinery with edge-based closed loop control, mobile collaborative robots and others.

Although it is tempting to solve this issue by over-engineering the deployment, for example, by adding many extra wireless transceivers e.g. dots, this increases costs and energy expenditure and also places a strain on the planning processes to minimize interference between different cells.

As well as the problems noted above, shadows or coverage blackspots can cause a wide range of problems. One example is in collaborative machine learning processes whereby different nodes communicate with one another during training and this process can be disrupted if a node loses connection.

Various multi-agent reinforcement learning (RL) processes have been proposed, such as the “Differentiable inter-agent learning” (DIAL) and “Reinforced inter-agent learning” (RIAL) processes described in the paper by Foerster et al. (2016) entitled: “Learning to Communicate with Deep Multi-Agent Reinforcement Learning” (arXiv: 1605.06676v2).

### SUMMARY

As noted above, it can be challenging to plan coverage in indoor spaces containing moving objects which can create coverage blackspots. Multi-agent RL may in theory be used to solve coverage problems by dynamically predicting where wireless transceivers are to be placed based on real-time measurements. However, the multi-agent RL process is also affected as, since there is no (or intermittent) coverage, the different agents may be unable to communicate with each other either. Yet, a good enough action-value function still needs to be obtained even if agents cannot always communicate with each other due to the existence of shadows. The agents still need to be able to continue functioning and learn an optimal policy.

It is an object of embodiments herein to improve multi-agent RL processes in situations where the process is impacted by poor communication between agents, e.g. due to coverage blackspots.

According to a first aspect there is a method performed by a first node in a communications network, as part of a multi-agent reinforcement learning, RL, process involving a second node in the communications network. The method comprises: i) predicting first state-action-reward, s-a-r, information for the second node; ii) determining a first q-value, according to the multi-agent RL process, using the predicted first s-a-r as the contribution from the second node; iii) determining a second q-value, according to the multi-agent RL process, without taking a contribution from the second node into consideration; and iv) selecting a first action for the first node based on the first q-value and the second q-value.

According to a second aspect there is a first node in a communications network that acts as part of a multi-agent reinforcement learning, RL, process involving a second node in the communications network. The first node comprises: a memory comprising instruction data representing a set of instructions; and a processor configured to communicate with the memory and to execute the set of instructions. The set of instructions, when executed by the processor, cause the processor to: i) predict first state-action-reward, s-a-r, information for the second node; ii) determine a first q-value, according to the multi-agent RL process, using the predicted first s-a-r as the contribution from the second node; iii) determine a second q-value, according to the multi-agent RL process, without taking a contribution from the second node into consideration; and iv) select a first action for the first node based on the first q-value and the second q-value.

According to a third aspect there is a first node in a communications network that acts as part of a multi-agent reinforcement learning, RL, process involving a second node in the communications network. The first node is configured to: i) predict first state-action-reward, s-a-r, information for the second node; ii) determine a first q-value, according to the multi-agent RL process, using the predicted first s-a-r as the contribution from the second node; iii) determine a second q-value, according to the multi-agent RL process, without taking a contribution from the second node into consideration; and iv) select a first action for the first node based on the first q-value and the second q-value.

According to a fourth aspect there is a computer program comprising instructions which, when executed on at least one processor, cause the at least one processor to carry out the method of the first aspect.

According to a fifth aspect there is a carrier containing a computer program according to the fourth aspect, wherein the carrier comprises one of an electronic signal, optical signal, radio signal or computer readable storage medium.

According to a sixth aspect there is a computer program product comprising non transitory computer readable media having stored thereon a computer program according to the fourth aspect.

Thus, in embodiments herein, in scenarios where s-a-r information isn't available for the second node in a s-a-r-s′ round, a first q value is determined taking the predicted contribution of the second node into account, and a second q value is taken into account in the absence of a contribution from the second node. In this way, there is provided a mechanism for updating the policy and selecting an action to perform, according to a multi-agent RL process, even in scenarios where there is missing data from some of the nodes taking part in the multi-agent RL process. This addresses the intermittent coverage problem described above, allowing the multi-agent RL process to proceed even in scenarios where there is missing data due, e.g. to transmission failure due to a coverage blackspot.

There is thus provided a way of learning an action-value function in a collaborative manner in environments where there is lack of information from different agents. Put another way, there is a mechanism that allows for learning an action value in a multi-agent reinforcement learning setup when different agents are incapable of communicating with each other.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 shows a first node according to some embodiments herein;

FIG. 2 shows a computer implemented method performed by a first node according to some embodiments herein;

FIG. 3 shows three agents and the messages sent between them at different time points as part of a multi-agent RL process;

FIG. 4 shows a signal diagram between a first node and a second node according to embodiments herein;

FIG. 5 shows another signal diagram between a first node and a second node according to embodiments herein;

FIG. 6 shows a smart factory layout;

FIG. 7 shows how a coverage shadow may be introduced as robots move around the smart factory; and

FIG. 8 shows a RSRP matrix of coverage for different cells in a smart factory.

### DETAILED DESCRIPTION

The disclosure herein relates to a communications network (or telecommunications network). A communications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that the communications network may comprise other types of links. A wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, 5G and any next generation standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

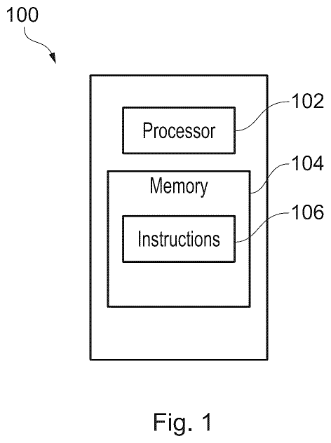

FIG. 1 illustrates a first node 100 (which may otherwise be referred to as a first network node) in a communications network according to some embodiments herein. Generally, the first node 100 may comprise any component or network function (e.g. any hardware or software module) in the communications network suitable for performing the functions described herein.

For example, a node may comprise equipment capable, configured, arranged and/or operable to communicate directly or indirectly with a UE (such as a wireless device) and/or with other network nodes or equipment in the communications network to enable and/or provide wireless or wired access to the UE and/or to perform other functions (e.g., administration) in the communications network. Examples of nodes include, but are not limited to, access points (APs) (e.g., radio access points), base stations (BSs) (e.g., radio base stations, Node Bs, evolved Node Bs (eNBs) and NR NodeBs (gNBs)). Further examples of nodes include but are not limited to core network functions such as, for example, core network functions in a Fifth Generation Core network (5GC), or any future networks such as Sixth Generation networks (6G).

In some embodiments, the first node is an Integrated Access and Backhaul (IAB) node, such as an IAB mobile termination node (IAB-MT). IAB-MTs attach to IAB-donor nodes as terminals (hence the MT) and allow traffic to be transferred between a user equipment (UE) attached to the IAB-MT node all the way up to the IAB-Donor. An IAB-Donor is a logical node that provides New Radio (NR)-based wireless backhaul. In such a setup the IAB-MT node delivers fixed wireless access in indoor/outdoor environments where it is not cost-effective to provide access otherwise.

In more detail, in some embodiments, the first node is a wireless device (otherwise known as a user equipment). A wireless device may comprise a device capable, configured, arranged and/or operable to communicate wirelessly with network nodes and/or other wireless devices. Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc..

As one example, a wireless device may be a wireless device implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.).

A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a mobile device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as an MTC device. In other scenarios, a wireless device may represent a vehicle or other equipment that is capable of monitoring and/or reporting on its operational status or other functions associated with its operation.

A wireless device as described above may represent the endpoint of a wireless connection, in which case the device may be referred to as a wireless terminal.

In some embodiments, the first node 100 is comprised in a first mobile device. In this sense, a mobile device is a wireless device, as described above, that is moveable (e.g. mobile). A mobile device may also be referred to as a mobile terminal.

The first mobile device may be, for example, an automated guided vehicle (AGV). Examples of AGVs include but are not limited to machinery in a smart-factory environment that is operated remotely via the communications network. As another example, a mobile device may be an unmanned aerial vehicle (UAV) e.g. a drone.

In embodiments where the first node and/or the second node are AGVs, each AGV unit could be implemented as an IAB-MT as described above, thus allowing other nearby devices to send their traffic to an IAB donor node.

The first node 100 is configured (e.g. adapted, operative, or programmed) to perform any of the embodiments of the method 200 as described below. It will be appreciated that the first node 100 may comprise one or more virtual machines running different software and/or processes. The first node 100 may therefore comprise one or more servers, switches and/or storage devices and/or may comprise cloud computing infrastructure or infrastructure configured to perform in a distributed manner, that runs the software and/or processes.

The first node 100 may comprise a processor (e.g. processing circuitry or logic) 102. The processor 102 may control the operation of the first node 100 in the manner described herein. The processor 102 can comprise one or more processors, processing units, multi-core processors or modules that are configured or programmed to control the first node 100 in the manner described herein. In particular implementations, the processor 102 can comprise a plurality of software and/or hardware modules that are each configured to perform, or are for performing, individual or multiple steps of the functionality of the first node 100 as described herein.

The first node 100 may comprise a memory 104. In some embodiments, the memory 104 of the first node 100 can be configured to store program code or instructions 106 that can be executed by the processor 102 of the first node 100 to perform the functionality described herein. Alternatively or in addition, the memory 104 of the first node 100, can be configured to store any requests, resources, information, data, signals, or similar that are described herein. The processor 102 of the first node 100 may be configured to control the memory 104 of the first node 100 to store any requests, resources, information, data, signals, or similar that are described herein.

It will be appreciated that the first node 100 may comprise other components in addition or alternatively to those indicated in FIG. 1. For example, in some embodiments, the first node 100 may comprise a communications interface. The communications interface may be for use in communicating with other nodes in the communications network, (e.g. such as other physical or virtual nodes). For example, the communications interface may be configured to transmit to and/or receive from other nodes or network functions requests, resources, information, data, signals, or similar. The processor 102 of first node 100 may be configured to control such a communications interface to transmit to and/or receive from other nodes or network functions requests, resources, information, data, signals, or similar.

Briefly, in one embodiment, the first node 100 may act as part of a multi-agent reinforcement learning, RL, process involving a second node in the communications network. The first node may be configured to i) predict first state-action-reward (s-a-r), information for the second node; ii) determine a first q-value, according to the multi-agent RL process, using the predicted first s-a-r as the contribution from the second node; iii) determine a second q-value, according to the multi-agent RL process, without taking a contribution from the second node into consideration; and iv) select a first action for the first node based on the first q-value and the second q-value.

The first node 100 performs a multi-agent reinforcement learning process with a second node in the communications network. The second node is another node in the communications network. The second node may be a wireless device, or mobile device. Wireless devices and mobile devices were described in detail above with respect to the first node and the detail therein will be appreciated to apply equally to the second node. In some embodiments, the second node is an AGV or UAV, as described above,

The second node may comprise a processor, memory and/or instruction data. Processors, memories and instruction data were all described above with respect to the first node and the detail therein will be understood to apply equally to the second node and any other nodes in the communications network as described herein. The second node may perform the method 200 described below, in a reciprocal (or mirrored) manner to the first node.

The first node and the second node perform a multi-agent RL process. A multi-agent RL process is a type of RL process that is distributed across two or more agents that collaborate to learn a policy by sharing s-a-r information.

The skilled person will be familiar with reinforcement learning and reinforcement learning agents, however, briefly, reinforcement learning is a type of machine learning process whereby a reinforcement learning agent (e.g. process) is used to perform actions on a system (such as a communications network) to adjust the system according to an objective (which may, for example, comprise moving the system towards an optimal or preferred state of the system). The reinforcement learning agent receives a reward based on whether the action changes the system in compliance with the objective (e.g. towards the preferred state), or against the objective (e.g. further away from the preferred state). The reinforcement learning agent therefore adjusts parameters in the system with the goal of maximising the rewards received.

Put more formally, a reinforcement learning agent receives an observation from an environment in state S and selects an action to maximize the expected future reward r. Based on the expected future rewards, a value function V for each state can be calculated and an optimal policy π that maximizes the long term value function can be derived.

In the context of this disclosure, in some embodiments herein, the method is performed by a first node in a communications network (or an agent thereon) and the set of features are obtained by the communications network. For example, the reinforcement learning agent may be configured for adjustment (e.g. optimisation) of operational parameters of the communications network. In such embodiments, the “environment” may comprise e.g. the network conditions in the communications network, the conditions in which the communications network is operating and/or the conditions in which devices connected to the communications network are operating. At any point in time, the communications network is in a state S. The “observations” comprise values relating to the process in the communications network that is being managed by the reinforcement learning agent (e.g. KPIs, sensor readings etc) and the “actions” performed by the reinforcement learning agents are the adjustments made by the reinforcement learning agent that affect the process that is managed by the reinforcement learning agent.

The multi-agent RL processes described herein involve a first agent on the first node 100 operating in collaboration with a second agent on a second node in the communications network, to determine an optimal policy.

In some embodiments, the multi-agent RL process is a differentiable inter-agent learning, DIAL, reinforcement learning process, or a Reinforced Inter-Agent Learning, RIAL process. RIAL and DIAL are described in the paper entitled: “Learning to Communicate with Deep Multi-Agent Reinforcement Learning” by Foerster et al. (2016) arXiv: 1605.06676v2.

More generally, the first node 100 may be configured to perform any multi-agent RL process where the agents broadcast to other agents in the setup (e.g. in a decentralised manner) that comprises an action value function, q, (which can also be called a policy), that is learnt as part of the multi-agent RL process. Typically an optimal policy is referred to as q* (star) when the model is trained.

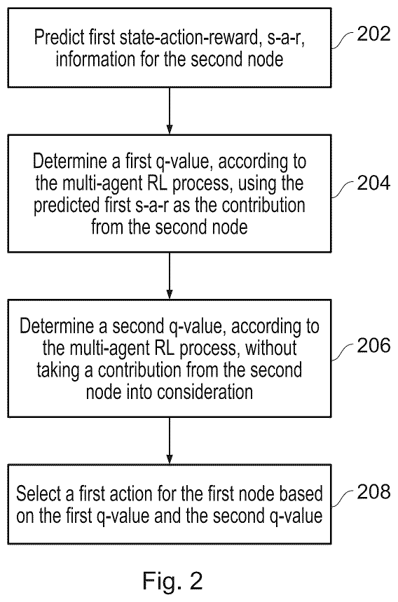

Turning now to FIG. 2 which shows a computer implemented method 200 performed by a first node in a communications network as part of a multi-agent reinforcement learning, RL, process involving a second node in the communications network, according to some embodiments herein. The method 200 may be performed by the first node 100 described above. In brief, in a first step 202 the method 200 comprises i) predicting first state-action-reward, s-a-r, information for the second node. In a second step 204 the method comprises ii) determining a first q-value, according to the multi-agent RL process, using the predicted first s-a-r as the contribution from the second node. In a third step 206 the method comprises iii) determining a second q-value, according to the multi-agent RL process, without taking a contribution from the second node into consideration. In a fourth step 208 the method comprises iv) selecting a first action for the first node based on the first q-value and the second q-value.

Generally, as part of the multi-agent reward process, the first node may receive s-a-r information from the second node. In response to the s-a-r-information, the first node may update a policy, or q-value, and use the updated q value in order to select the next action to perform. s-a-r information may be received from the second node at predefined times (or time intervals) that are known to the first node. In other words the first node may expect to receive s-a-r information from the second node.

The method 200 may be performed as part of the multi-agent RL process when calculating the policy, q, in response to a round of s-a-r-s information being obtained. In particular, but non-exclusively, the method 200 herein may be performed as part of the multi-agent reward process in order to update the q-value in scenarios where s-a-r information has not been received from the second node (as expected).

In some embodiments, the method 200 may be performed in response to the first node not receiving actual s-a-r information from the second node within a predefined time limit. The predefined time limit is a time limit in which the first node is expecting to receive s-a-r information from the second node.

For example, the first node may not receive the actual s-a-r information from the second node due to an unsuccessful message exchange between the first node and the second node. In other words, the first node may not receive a message from the second node comprising the s-a-r information, even though the second node tried to send said message.

An unsuccessful message exchange may be due to (e.g. caused by) wireless connectivity. For example, due to a blackspot. Such a black spot may be a temporary black spot, e.g. caused by moving objects or machinery in the environment. An unsuccessful message exchange could also be due to other technical failure, such as a software update, wireless transceiver error, or for any other reason.

If actual s-a-r information is not received from the second node, then in step 202 the first node predicts first state-action-reward, s-a-r, information for the second node. For example, the first node may predict what the second node would have sent. The actual message contents from the second node at time t may be denoted m(t), and the predicted message contents may be denoted m′(t) herein.

In step 202, the first node may predict the s-a-r information for the second node in any manner. As an example, the first node may use machine learning to predict the s-a-r information, based on historical s-a-r information for the second node. For example, the first node may save previously received s-a-r information received from the second node that may have been received in previous rounds of training, and use this to train a machine learning model, to predict the current s-a-r information for the second node.

The skilled person will be familiar with machine learning models such as, for example, neural network models that can be used to predict an output based on one or more input parameters.

In some examples, the prediction may be performed using a time-series prediction method such as, for example, Long short-term memory (LSTM) network as described in the paper by S. Hochreiter and J. Schmidhuber, entitled “Long short-term memory,” Neural Computation, vol. 9, no. 8, pp. 1735-1780 November 1997.

The time series can either be univariate, e.g. comprising an ordered sequence of past messages, or multi-variate comprising, e.g. an ordered sequence of past messages state, action and new state from the second node. The selection may depend on the accuracy of the prediction required and/or the available computational resources.

For example, the inputs to a LSTM may be the time, t, and identifier for the second node and a change in state since the last time the second node sent s-a-r information. This may be denoted:

$${m}^{′} ( t ) \text{<-} predict ( t , R 2 , delta ( s ( t - 1 ) , s ) ;$$

where m′(t) is the predicted message at time t, R2 is the identifier for the second node and delta (s(t−1),s) is the change in state, s.

It will be appreciated that LSTMs are merely an example however and that other types of machine learning model may equally be used, for example, Autoregressive Integrated Moving Average (ARIMA) which can be used for this problem. ARIMA is more statistical compared to LSTM which relies on forward/backward propagation. Another technique that may be used to make the prediction in step i) is the Holt winter's additive method.

In step ii) of the method 200, the method comprises determining 204 a first q-value, according to the multi-agent RL process, using the predicted first s-a-r as the contribution from the second node. In other words, the predicted s-a-r information is used in place of actual s-a-r information to calculate a q-value.

The q-value is calculated in the normal way, according to the particular multi-agent RL process. For example, the first q-value may be determined according to:

$$q\_alpha \text{<-} calculate\_q ( {m}^{′} ( t ) , m ( t - 1 ) , a ) ;$$

where q_alpha denotes the first q-value, m′(t) is the predicted message comprising the s-a-r information for time t and m(t−1) is the previously received message at time t−1 (e.g. the previous timestep or previous round of training).

In step iii) of the method 200, a second q-value is determined 206, according to the multi-agent RL process, without taking a contribution from the second node into consideration. In other words, the q-value is recalculated, in the absence of a contribution from the second node.

The second q-value is calculated in the normal way, according to the particular multi-agent RL process, just without any contribution from the second node. For example, the second q value may be determined according to:

$$q\_beta \text{<-} calculate\_q ( m\_d ( t ) , m ( t - 1 ) , a ) ;$$

where q_beta denotes the second q-value; m_d (t) is the message where the contribution from the second node is removed, m(t−1) is the message from the previous time iteration, and a is the action.

It will be appreciated that steps ii) and iii) above can be generalised to more than two nodes. For example, the multi-agent reinforcement learning process can involve a plurality of other nodes in the communications network. In such embodiments, the first q-value may be further determined, according to the multi-agent reinforcement learning process, using a plurality of s-a-r information obtained from the plurality of other nodes. The second q-value may also be determined, according to the multi-agent reinforcement learning process, using the plurality of s-a-r information obtained from the plurality of other nodes, without any contribution from the second node.

Even though there may be no contribution from the second node, the method 200 will be repeated to identify if a contribution is needed from the third node and then the fourth node (e.g. using p values for the third and fourth nodes) and so on, for each of the plurality of nodes.

Turning now to step iv), a first action for the first node is then selected 208 based on the first q-value and the second q-value. In some embodiments, the method comprises using the first q-value in the multi-agent RL process to select the first action, if the first q-value is greater than the second q-value; or using the second q-value in the multi-agent RL process to select the first action, if the first q-value is less than the second q-value. If the first q-value is greater than the second q-value then the contribution made by the predicted s-a-r information from the second node produces a higher q value and as such is valuable, otherwise it is not.

The first action may further be based on a third q value, calculated just based on s-a-r information for the first node (e.g. a “selfish” q-value). The third q-value is what would be determined if the first node were performing an individual RL process.

The method may then comprise selecting the “best” e.g. highest q-value of the first q value and the second q-value and combining the selected q-value with the first q value to select an action.

Thus, if the first q-value is greater than the second q-value, then the first action may be selected according to: select_action (e, q, q_alpha), where q_alpha is the second q-value and q is the third q-value.

If the second q-value is greater than the first q-value, then the first action may be selected according to: select_action (e, q, q_beta), where q_beta is the second q-value and q is the third q-value.

In embodiments where there are a plurality of nodes in the multi-agent RL process, the action may be selected according to select_action (c, q_max_N, q_alpha) or select_action (e, q_max_N, q_beta) respectively. In other words, in the equations above, the third q-value (e.g. the isolated, or selfish q calculated just for the first node as it would be in a single RL process) may be replaced by q_max_N (the best q so far from all the nodes).

Thus, in this way, an action can be selected that takes into account predicted s-a-r information for the second node, when real s-a-r information is unavailable. This modification to multi-agent RL processes is motivated by the internal functioning of the communications network as it is designed to overcome the problems associated with training multi-agent RL models where the agents are periodically unavailable due to e.g. communications issues.

Turning now to other embodiments, if following a failed message exchange, the second node is able to send the actual s-a-r information to the first node (at a later time), then this may be used to verify the first action and/or update the manner in which the predictions are made in step i). For example, the actual s-a-r information may be used as ground-truth in a training example for training a neural network; it may also be used as another point in a time series for use in training an LSTM.

Thus, in some embodiments, subsequent to steps i), ii) iii) and iv), the method 200 may comprise receiving the actual s-a-r information from the second node; and using the predicted first s-a-r information and the received actual s-a-r information to update a prediction mechanism used to make the prediction in step i) and/or updating a policy of the multi-agent RL process, using the actual s-a-r information.

In some embodiments, steps i)-iv) are only performed if it is likely that the contribution of the second node would have been significant or impacted the selection of the first action. The significance or impact may be measured, for example using a probability or p value that indicates whether using the first q-value or the second q-value impacted a first reward received by the first node following the first action being performed. Put another way, in some embodiments, the method 200 further comprises: determining a first probability value, p, for the second node, wherein the first p-value indicates whether using the first q-value or the second q-value impacted a first reward received by the first node following performance of the first action.

In some embodiments, the first p-value is calculated according to the following equation:

$$p ( R 2 , t ) = floor ( p ( R 2 ) - p ( R 2 , t - 1 ) * γ , 0 )$$

where the floor function maps a number to the closet smallest integer (as opposed to ceiling which finds the closest largest integer). p(R2) may be initialised e.g. by setting it to the highest or to the lowest value: 0 or 1. In practice, the initialisation value doesn't generally affect the process, since the formulas described previously will add or remove the contribution accordingly, but their effect will never be less than 0 or higher than 1 Since here we want to measure how much P2 is contributing we subtract the current contribution p(R2) from itself multiplied by a small factor called y, “gamma” (gamma is typically used in RL to denote a discount). gamma can be a real value between 0 and 1, such as for example, 0.3 and may be set e.g. as a configuration parameter. A higher gamma value would indicate that we have no long term belief that the agent's contribution matters (so we go ahead and discount it immediately), while a lower value means that we expect that the agent's contribution will become more meaningful in the next iterations. So let's say the contribution is 1, we do not subtract 1 directly but if gamma is set to 0.3, we subtract 1*0.3, so a portion of 1. The 0 at the end in the floor function is that this number should be as low as zero.

The p value can be used to determine whether the contribution from the second node is likely to be important/useful or not.

In some embodiments, in a subsequent round of training, if real s-a-r information is not received for the second node, then the first p value may be used to determine whether to perform steps i)-iv). If the first p-value is greater than a threshold p-value then this may trigger step i) to be performed and the s-a-r information for the second node to be predicted as described above.

If the p value indicates that the contribution from the second node is unlikely to be important, then in the subsequent round of training, the contribution from R2 may be ignored (e.g. the prediction may be omitted) and instead a next action may be determined using the third q-value described above, e.g. a q-value determined only using the first node's s-a-r information. In this scenario, q<-calculate q (s,a).

Once the first action is determined, the method 200 may subsequently comprise performing the first action, or causing the first action to be performed. For example, the first node may send a message to another node in the communications network to cause the first action to be performed. New state information is then obtained following the action being performed and new s-a-r information is obtained.

As the second node also performs the method 200, the second node also has new s-a-r information, which will be referred to herein as second s-a-r information, which is sent to the first node as part of the multi-agent RL process.

If the second s-a-r is sent unsuccessfully, the steps i)-iv) may be repeated.

If the second s-a-r is sent successfully then the first node may perform the following steps: v) receive second state-action-reward, s-a-r, information from the second node; vi) determine a third q-value, according to the multi-agent RL process, using the second s-a-r as the contribution from the second node; vii) determine a fourth q-value, according to the multi-agent RL process, without taking the second s-a-r from the second node into consideration; and vii) determine a second probability value, p, for the second node, wherein the second p-value indicates whether using the third q-value or the fourth q-value impacted a second reward received by the first node following performance of a second action.

In other words, steps i)-iv) may be repeated using the real s-a-r information instead of the predicted s-a-r-information. This enables the multi-agent RL process to determine whether to use a policy influenced by the first node and the second node, or just the first node's input.

As noted above, steps v), vi), vii) and viii) may be performed in response to the first node (successfully) receiving the second s-a-r information from the second node.

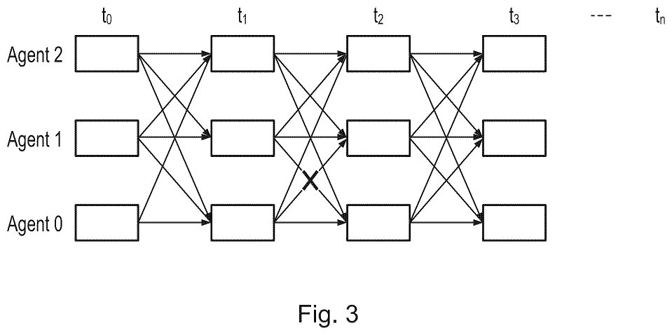

Turning now to FIG. 3, which illustrates the problem of action-value leakage in multi-agent RL. FIG. 3 shows three agents (labelled agents 0, 1 and 2) and the message sent between them for time steps t0, t1, t2 and t3. At t2, the message between agent 1 and agent 0 fails (illustrated by the black cross) due to a connectivity blackspot, as described above. This is a general problem in multi-agent RL in environments where there is poor or intermittent communication between agents (e.g. due to poor signal coverage, battery limitations, technical faults, or any other reason).

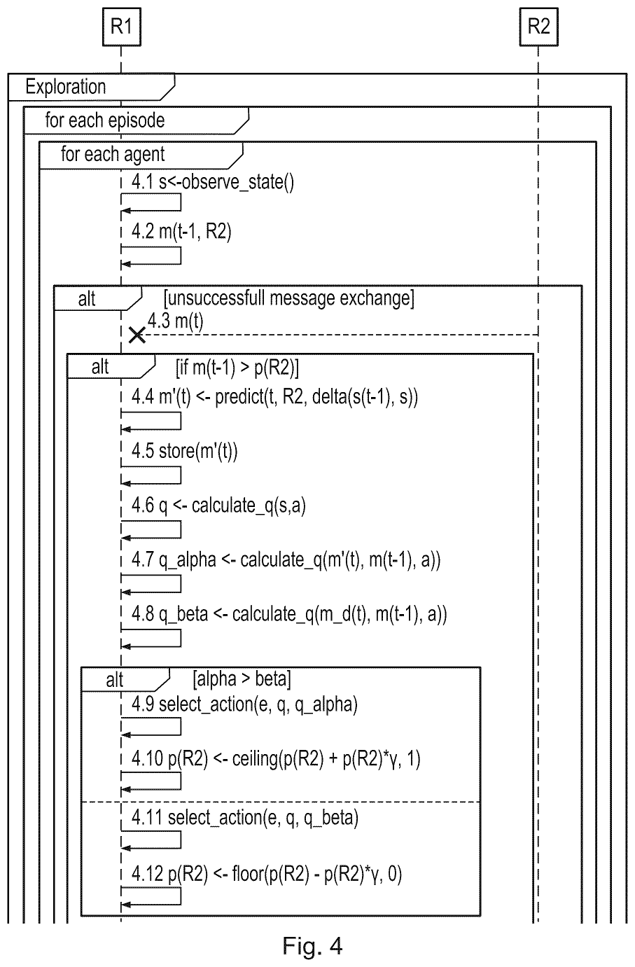

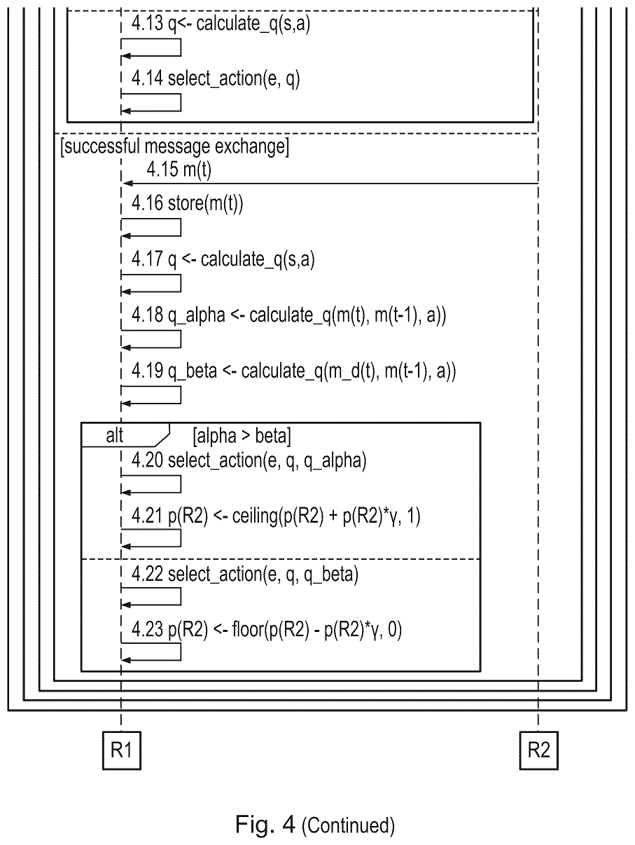

Turning now to FIG. 4 there is a signal diagram between a first node and a second node that are performing a DIAL multi-agent RL process between two nodes, in a scenario with intermittent coverage as illustrated in FIG. 3. In this example, the first node is a first mobile device in the form of a first robot (R1) and the second node is a second mobile device in the form of a second robot (R2). Although it will be appreciated this this is merely an example and R1 and R2 may generally refer to a first node and a second node.

In this example, a variation of the DIAL multi-agent RL process is used, which differs from the original since the agents on the first and second nodes cannot always communicate with each other due to the existence of shadows (areas with poor communication low RSRP/RSRQ). Still the agents need to be able to continue functioning and learn an optimal policy.

As described above, the main intuition behind this proposal is that of predicting the message exchanges from each agent based on previous messages and observations of the common shared environment. Moreover, in a Collaborative Multi Agent Reinforcement Learning (MARL) setup there is potential for information leakage between agents since each Q action-value function is affected by other agents. This is also illustrated in FIG. 3 where at t2, although Agent 1 can no longer communicate with Agent 0, it can communicate with Agent 2. In t3, since Agent 2 can communicate with Agent 0 (and Agent 1) Agent 1's influence is indirectly passed to Agent 0.

An embodiment of the method 200 is illustrated in the sequence diagram shown in FIG. 4. As per the approach proposed by DIAL two Q action value function network are learned q which learns the action and q_which learns action using the message from the other agent. In our case we extend q_with q_alpha and q_beta which are used to learn whether the messages from the other robot (predicted or not) have impacted the reward of the agent or not and that is stored in each agent's p table which is a matrix that holds n elements (as many as the agents) that communicate with the source agent (R1 in this case).

The process takes place for each episode during the exploration phase but can also be applied in the exploitation phase when there are missing messages. In this example, the following messages are sent:
4.1. R1 (robot 1) observes its state—the state here can be a temporal RSRP grid which can be observed by all robots—if R2 is far away and has turned its repeater on it is possible to detect that since R1 will be able to get a measurement of that.
4.2. R1 retrieves the message that it received from robot 2 (R2) which contains a representation of r2's state and action for the time step, t−1.
4.3. R2 sends its current message to R1 which contains its current state and action at moment t. In this case and for the purpose of illustrating our proposal we assume that this message exchange fails.
4.4. R1 needs to determine if R2's previous contribution (e.g. at t−1) was useful or not. To do that it consults its local p table which is updated accordingly in steps 10 and 12. If the contribution was useful then R1 proceeds with predicting the missed message according to step 202 described above, using input from previously stored messages and the delta between the current state and the previous state
4.5. The predicted message (from R2) is stored to produce a history of messages. To further enhance the training of the model we can differentiate between predicted and real messages
4.6. R1 calculates its Q action-value using s and current action (e.g. based on the first node's s-a-r information). This may be considered a “selfish” q.
4.7. R1 calculates a first q-value (denoted Q_alpha) using the current predicted message from r2, the previous message from r2 and its current action, according to step 204 described above.
4.8. R1 calculates a second q value (denoted Q_beta) according to the multi-agent RL process, based on m_d (t) which is the contribution of all of the other agents in the multi-agent RL process, not including the second node, without taking a contribution from the second node into consideration (according to step 206 described above).
   The first node then performs step 408 to choose an action. If the max (a, Q_alpha)>max (a, Q_beta) then the input of R2 produces higher Q value and as such is valuable, otherwise it is not.
4.9. In this case (alpha>beta) R1 picks an action using e greedy policy which either chooses the next action randomly or the max action combining Q and Q_alpha action-values
4.10. The utility of this choice is stored in R1's p table for R2
4.11. If beta is greater-R2 input was not useful the next action is chosen using input from Q action value and Q_beta
4.12. The utility of this choice is stored in R1's p table for R2
4.13. If (at steps 4.3 and 4.4 above), from the p-table, R2's contribution is not useful based on the previous iteration, the prediction is omitted and instead a next action is calculated using only the R1 agent's Q action-value.
4.14. We choose the next action using the Q action value calculated previously without input from R2
4.15. In the case where the message from R2 is received successfully, it is stored and the method repeats steps 4.6 (now 4.17), 4.7 (now 4.18), 8 (now 4.19), 4.9 (now 4.20), 4.10 (now 4.21), 4.11 (now 4.22), 4.12 (now 4.23) to learn about R2's contribution without predicting a message but at the same time collecting historical information that will support the predictive model used in step 4.

It will be appreciated that FIG. 4 only illustrates the messages exchanged in a scenario where there are two nodes involved in the multi-agent RL process. In a scenario where there are a plurality of nodes, the method may be extended according to the principles described above with respect to FIG. 2. For example, in embodiments where there is a plurality of nodes, a best q value (e.g. the maximum of all of the previous q_alpha, and q_beta values, which may be denoted q_max_N, as described above) may be stored and this may be used instead of the q (s,a) (the third q-value e.g. the isolate or “selfish” q described above).

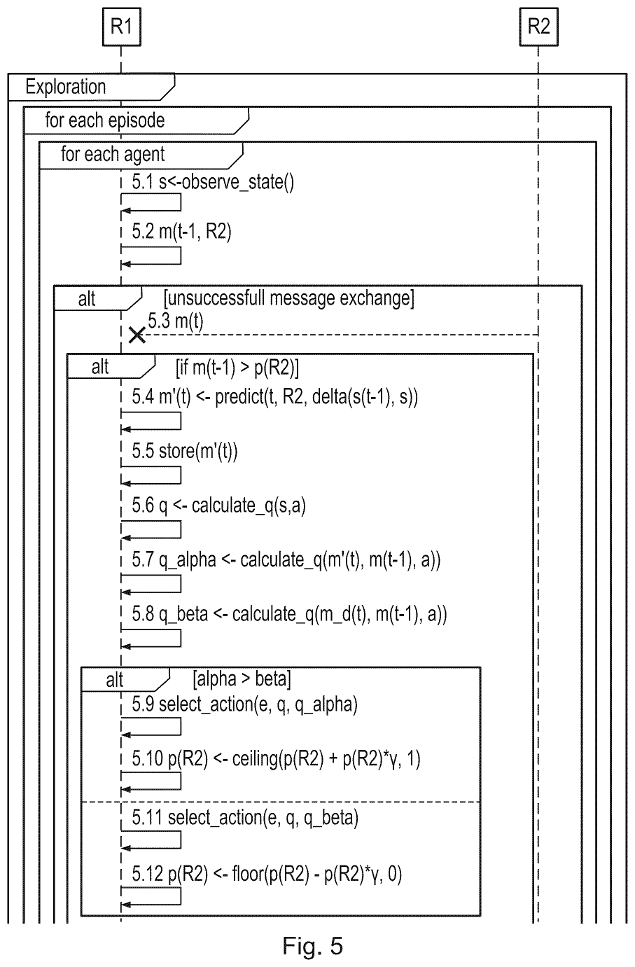

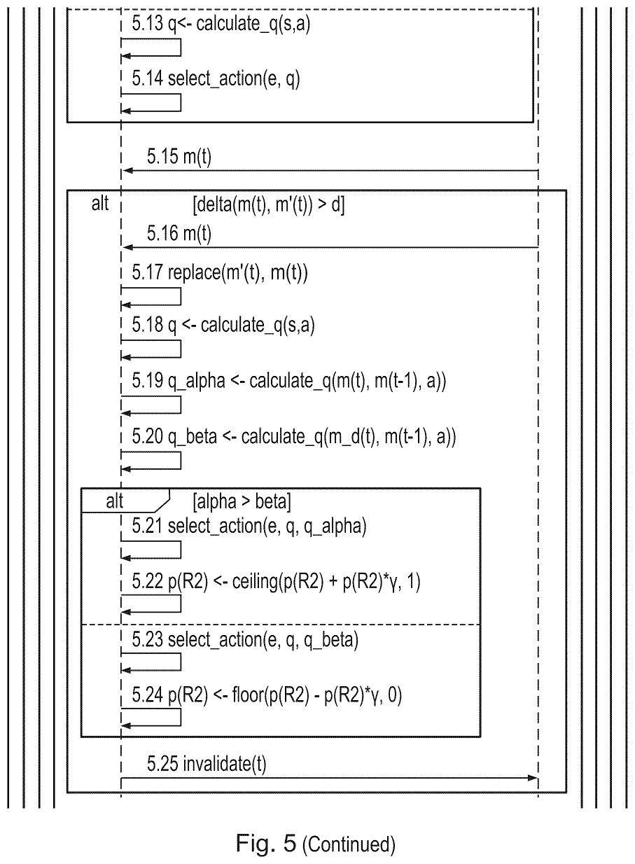

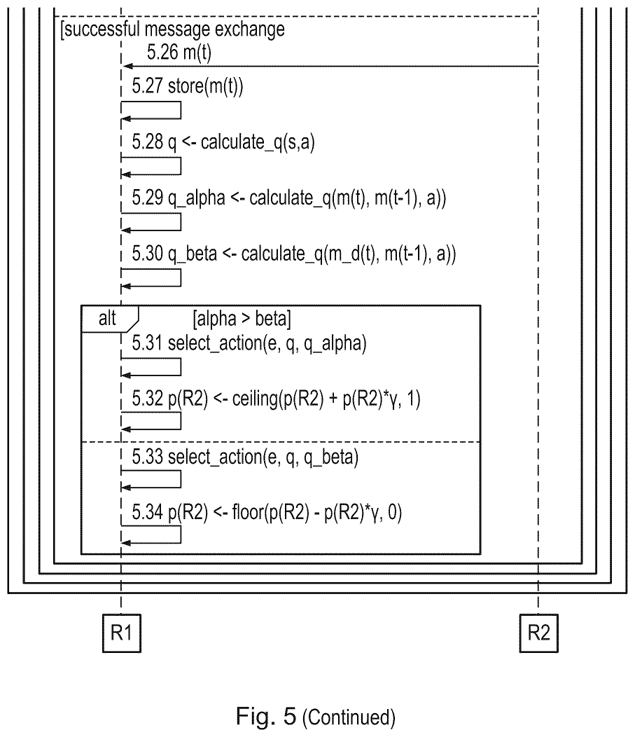

Turning now to FIG. 5, which shows a message exchange between two robots R1 and R2 according to another embodiment herein. The method 200 can also be applied in the case when a message is not received (e.g. message loss) due to a timeout, e.g., in the case where R1 waits too long for a message from R2. In that case the message may still arrive, but it will arrive much later than expected. Assuming that the message is timestamped and R1 eventually receives the wanted message (based on the timestamp)—this message can be used to validate/invalidate the predicted m′(t). Assuming a historical buffer of depth k, if t within t . . . t(k) (where t(k) is the timestamp of the old message in the historical buffer), if delta (m′(t), m(t))>d the process can invalidate and produce a new policy using the time delayed input m(t) recursively. This is illustrated in FIG. 5 whereby steps 5.1-5.14 are the same as steps 4.1-4.14 as described above with respect to FIG. 4, steps 5.26-5.34 are the same as steps 4.15-4.23. Steps 5.15-5.25 are performed as follows:

5.15 A message is received for time t
5.16 The difference between the message and a predicted message m′(t) is greater than a threshold difference
5.17 The predicted message m′(t) is replaced by the received (actual) message m(t)
5.18 q is calculated using local s and a without considering any other input
5.19 q_alpha (the first q-value) is calculated, using current combined message from all actors and previous combined message form all actors
5.20 q_beta (the second q-value) is calculated without the current input from R2 and the previous combined message of all agents
5.21 Depending on which value function yields higher reward-if that is alpha (the one where we consider the input from all other agents) then we use that to selection our action combined with the third q-value, q
5.22 The influence of R2 (p2) is then updated to promote the contribution of R2 p(R2,t)<-ceiling (p(R2,t)+p(R2,t−1)*g,1)
5.23 If beta is better than alpha we combine q_beta with q to select an action
5.24 We demote the contribution of beta p(R2,t)<-floor (p (R2,t)−p(R2,t−1)*g,0)
5.25 We ask R2 to invalidate the prediction it made for time point t since the out-of-band message has been received.

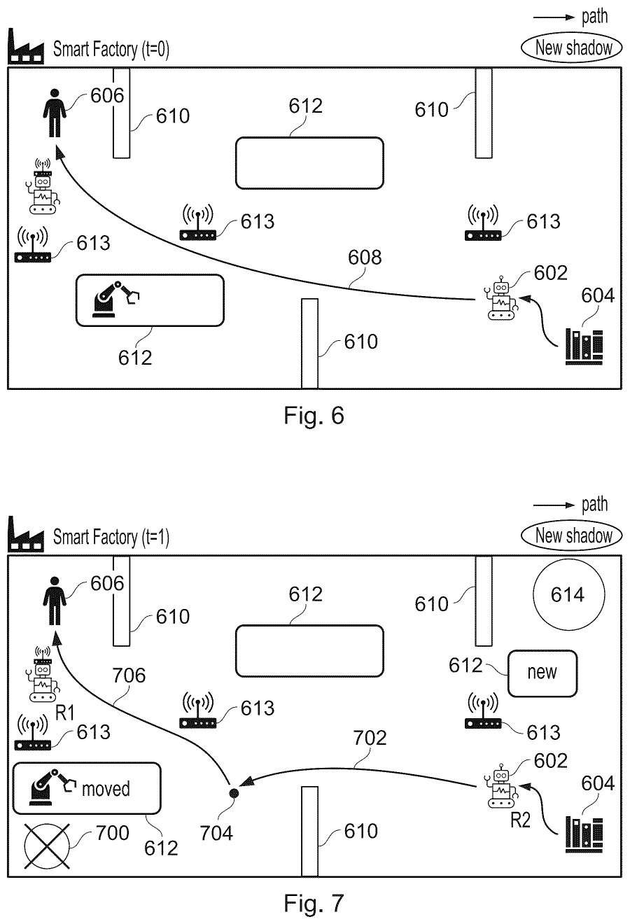

Turning now to FIG. 6, in some embodiments, the method 200 may be applied to smart manufacturing environments. A smart manufacturing environment is one where one or more machines operating in the manufacturing environment are operated remotely via a communications network. This is illustrated in FIG. 6 which shows a smart manufacturing environment at a time point t=0 in which a robot 602 receives instructions 604 to move towards person 606 via the route 608. The smart manufacturing environment contains moveable equipment 612 as well as fixed equipment/infrastructure 610 and wireless transceivers 613.

FIG. 7 shows the same environment, at time t=1 at which point new shadows 614, or coverage blackspots may be introduced by, e.g., due to movement of equipment or infrastructure.

According to embodiments herein, coverage blackspots may be reduced through the use mobile repeaters, which can be mounted on dedicated mobile robots or in already deployed AGVs. The challenge is to develop a method that learns and predicts QoS degradation, while integrating route and task planning to avoid it. The method should minimize predicted QoS degradation, while maximizing task efficiency. One solution for solving this problem is a centralized approach where all updates for the coverage of different parts of the factory are transferred continuously over the wire. However, such a solution would be very expensive proportionately to the number of agents since that would increase the amount of updates/cost of maintaining such information. A decentralized approach would be the next obvious choice but the problem there is that the different agents/robots might not be able to talk to each other due to poor coverage.

By applying the method 200 to this scenario, a decentralized approach is introduced where static cells and mobile agents, equipped with mobile repeaters that are turned on/off in an optimal fashion when they detect such gaps, are used to improve coverage. This is performed in a manner capable of converging to an optimal policy even when different agents cannot communicate with one another.

In the scope of this problem space there is currently a growth in the sales of AGVs which allows them to be equipped with mobile repeaters and as such allows them to be used to compensate for any shadows that might occur, coverage-wise, when layout changes take place or other sources of interference occur in the manufacturing space. The idea is to reuse those existing AGVs as much as possible to keep costs down, although acquiring cheaper drones for extending coverage using this method is also a possibility.

In more detail, in some embodiments, robots R1 and R2 equipped with wireless transceivers, or repeaters, self-organize, in a decentralized manner, in order to reduce, or eliminate if possible, shadows.

Thus, in this embodiment the first node is comprised in a first automated guided vehicle, AGV, and the second node is comprised in a second AGV. The first AGV and the second AGV are deployed in a manufacturing environment whereby one or more machines operating in the manufacturing environment are operated remotely via the communications network. The first AGV is equipped with radio capabilities, for example, it may comprise a repeater, an eNB/gNB, a radio dot, an IAB mobile terminal, a wireless access point, a first wireless transceiver or similar. The second AGV may also be equipped with radio capabilities.

In this embodiment, the multi-agent RL process is used to predict actions for the first AGV, wherein each action: sets a trajectory for the first AGV in the smart-factory; and/or determines whether the first wireless transceiver on the first AGV is to be turned on or off. The rewards in the multi-agent RL process may be allocated as a result of actions, based on whether wireless signal coverage in the smart-factory increased or decreased following a respective action being performed, compared to before the respective action was performed. As such, the goal of the multi-agent RL process may be to optimise placement of the robots in the smart manufacturing environment in order to enable them to perform their functions/tasks whilst also maximising signal coverage.

As such, rewards in the multi-agent RL process may also be given as a result of actions based on whether the first AGV moved closer to a first location set for the first AGV or further away from the first location following the respective action being performed, compared to before the respective action was performed. For example, the first location may be associated with a task that needs to be performed by the first node.

Rewards may also be allocated based on battery discharge or battery discharge rate. For example, rewards in the multi-agent RL process can be given as a result of each action based on the battery discharge rate of the first AGV such that larger battery discharge as a result of a respective action leads to lower rewards compared to lower battery discharge. This reduces power consumption of the AGVs and reduces down-time needed for re-charging.

### State Space

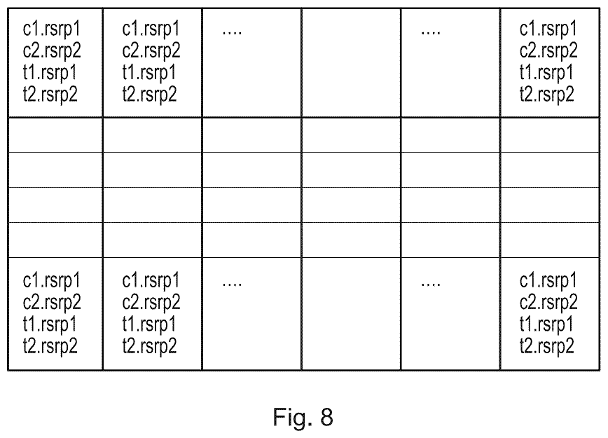

In one embodiment, the inputs to the multi-agent RL process (e.g. the state information) is a RSRP or RSRQ temporal grid, as illustrated in FIG. 8. This can be an n*m grid which contains RSRP values for each cell as measured by each robotic agent at a different point in time. Each cell records 1 or 0 for each cell if RSRP is greater or lower than a certain threshold. With c we denote stationary cells while with t we denote temporary cells which are onboarded on the robotic agents (mobile repeaters). Based on these design choices the RSRP temporal grid is very small to store since we only use binary values. Beyond the RSRP/RSRQ grid other inputs may be the battery levels of each AGV (or agent in general) and one or more trajectories that each AGV has been assigned in the scope of fulfilling their task. It will be appreciated that these are merely examples and that other coverage measures can equally be used. Furthermore, the use of binary values is merely an example and in other examples, the coverage may be expressed as integers, floats, or in any other manner.

### Action Space

For simplicity, assume that each agent is constantly moving. As such, the action choices can be limited to those off deciding how many degrees to rotate the direction of the agent i.e., +30, 0, or −30 degrees as an example. Moreover, in order for the agent to learn whether the mobile repeater is to be turned on, or off, the following sets of actions may be proposed:
0: {-30, off}
1: {-30, on}
2: {30, off}
3: {30, on}
4: {0, off}
5: {0, on}
   As such, in this example, the action space has 6 actions.
   It will be appreciated that this is merely an example however and that a larger action space may be compiled, for example, with different trajectory information (e.g. with different angle combinations, stop, start and/or any other trajectory information)

### Reward Function

$$R ( s , a , r , {s}^{′} ) = \{ \begin{matrix}1 - \frac{norm ( distance ( s [ location ] , s [ goal ] ) )}{battery\_dicharging \_rate} , & {s}^{′} [ CW ] - s [ CW ] \geq 0 \\ r - \frac{{P}^{*}}{battery\_discharging \_rate} , & {s}^{′} [ CW ] - s [ CW ] < 0\end{matrix}$$

In this example, the reward function is designed to reward the agent when coverage is improving and to penalize the agent when that is not the case. Coverage (denoted as CW) is determined by the RSRP/RSRQ map we noted previously. As an example:

$$CW = {\sum }_{i , j}^{n , m} c ( i , j ) where i \leq n and j \leq m and c ( i , j ) ∈ [ 0.1 ]$$

Coverage may be stored in the state s. If new coverage obtained through s′ [CW] is better than previously or equal the agent receives the highest reward discounted by the distance between its current location and its goal location (denoted distance (s[location],s[goal])) divided by the rate of battery discharge.

If new coverage is worse than the agent receives a discount (e.g. negative reward or penalty) in its reward that, in this example, is defined by a punishment value, P*, divided by the rate of battery discharge. P* is set as a constant value, the value of which will depend on design requirements of the system.

The distance function can either be implemented as a simple Euclidean, Manhattan or other type of L1 norm approach to measuring distance between the current location of the agent and the location of the goal which is the target location that the agent has been tasked to go to. Alternatively, the distance function can be enriched to also consider other kinds of discrepancies for example how far is the agent from the original trajectory due to its additional goal to improve on coverage. As such the agent will learn to minimize such changes to conflict as little as possible with the agent's original goal.

Thus, there is provided an RL based optimization approach where different agents learn collaboratively when to turn their repeaters on/off and to divert slightly from their actual route to compensate for coverage shadows.

In another embodiment, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs, particularly computer programs on or in a carrier, adapted to put embodiments into practice. The program may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may include a data storage, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method performed by a first node in a communications network, as part of a multi-agent reinforcement learning, RL, process involving a second node in the communications network, the method comprising:
i) predicting first state-action-reward, s-a-r, information for the second node;
ii) determining a first q-value, according to the multi-agent RL process, using the predicted first s-a-r as the contribution from the second node;
iii) determining a second q-value, according to the multi-agent RL process, without taking a contribution from the second node into consideration; and
iv) selecting a first action for the first node based on the first q-value and the second q-value, comprising:
using the first q-value in the multi-agent RL process to select the first action, if the first q-value is greater than the second q-value; or
using the second q-value in the multi-agent RL process to select the first action, if the first q-value is less than the second q-value.

2. (canceled)

3. The method of claim 1, further comprising:
determining a first probability value, p, for the second node, wherein the first p-value indicates whether using the first q-value or the second q-value impacted a first reward received by the first node following performance of the first action.

4. The method of claim 1, wherein steps i), ii), iii) and iv) are performed in response to the first node not receiving actual s-a-r information from the second node within a predefined time limit.

5. The method of claim 4, wherein the first node does not receive the actual s-a-r information from the second node due to an unsuccessful message exchange between the first node and the second node.

6. The method of claim 5, wherein the unsuccessful message exchange is due to wireless connectivity.

7. The method of claim 1, further comprising, subsequent to steps i), ii) iii) and iv) receiving the actual s-a-r information from the second node; and
using the predicted first s-a-r information and the received actual s-a-r information to update a prediction mechanism used to make the prediction in step i); or
updating a policy of the multi-agent RL process, using the actual s-a-r information.

8. The method of claim 1, wherein the method further comprises:
v) receiving second state-action-reward, s-a-r, information from the second node;
vi) determining a third q-value, according to the multi-agent RL process, using the second s-a-r as the contribution from the second node;
vii) determining a fourth q-value, according to the multi-agent RL process, without taking the second s-a-r from the second node into consideration; and
viii) determining a second probability value, p, for the second node, wherein the second p-value indicates whether using the third q-value or the fourth q-value impacted a second reward received by the first node following performance of a second action.

9. The method of claim 8, wherein steps v), vi), vii) and viii) are performed in response to the first node receiving the second s-a-r information from the second node.

10. The method of claim 1, wherein the multi-agent reinforcement learning process involves a plurality of other nodes in the communications network and wherein:
the first q-value is further determined, according to the multi-agent reinforcement learning process, using a plurality of s-a-r information obtained from the plurality of other nodes; and
the second q-value is further determined, according to the multi-agent reinforcement learning process, using the plurality of s-a-r information obtained from the plurality of other nodes.

11. The method of claim 1, wherein step iv) comprises using the first q value or the second q value as the policy function in the multi-agent RL process.

12. The method of claim 1, wherein the first node is comprised in a first mobile device in a first vehicle; or
wherein the second node is comprised in a second mobile device in a second vehicle.

13. The method of claim 12,
wherein the first vehicle is a first automated guided vehicle, AGV, and the second vehicle is a second AGV,
wherein the first AGV and the second AGV are deployed in a manufacturing environment whereby one or more machines operating in the manufacturing environment are operated remotely via the communications network, and
wherein the first AGV further comprises a first wireless transceiver.

14-15. (canceled)

16. The method of claim 13, wherein the multi-agent RL process is used to predict actions for the first AGV, wherein each action:
sets a trajectory for the first AGV in the smart-factory; or
determines whether the first wireless transceiver on the first AGV is to be turned on or off.

17. The method of claim 13, wherein rewards in the multi-agent RL process are given as a result of actions, based on whether wireless signal coverage in the smart-factory increased or decreased following a respective action being performed, compared to before the respective action was performed.

18. The method of claim 13, wherein rewards in the multi-agent RL process are given as a result of actions based on whether the first AGV moved closer to a first location set for the first AGV or further away from the first location following the respective action being performed, compared to before the respective action was performed.

19. The method of claim 13, wherein rewards in the multi-agent RL process are given as a result of each action based on the battery discharge rate of the first AGV such that larger battery discharge as a result of a respective action leads to lower rewards compared to lower battery discharge.

20. The method of claim 1, claims wherein the multi-agent RL process is a differentiable inter-agent learning, DIAL, reinforcement learning process, or a Reinforced Inter-Agent Learning, RIAL process.

21. The method of claim 1, further comprising causing the first action to be performed.

22. A first node in a communications network that acts as part of a multi-agent reinforcement learning, RL, process involving a second node in the communications network, the first node comprising:
a memory comprising instruction data representing a set of instructions; and
a processor configured to communicate with the memory and to execute the set of instructions, wherein the set of instructions, when executed by the processor, cause the processor to:
i) predict first state-action-reward, s-a-r, information for the second node;
ii) determine a first q-value, according to the multi-agent RL process, using the predicted first s-a-r as the contribution from the second node;
iii) determine a second q-value, according to the multi-agent RL process, without taking a contribution from the second node into consideration; and
iv) select a first action for the first node based on the first q-value and the second q-value.

23-25. (canceled)

26. A non-transitory computer-readable medium storing thereon a computer program comprising instructions which, when executed on at least one processor, cause the at least one processor to carry out the method of claim 1.

27-28. (canceled)
